(19) United States
(12) Patent Application Publication
(10) Pub. No.: US 2014/0060726 A1
(43) Pub. Date: Mar. 6, 2014

(54) METHODS FOR TRANSFERRING GRAPHENE FILMS AND THE LIKE BETWEEN SUBSTRATES

(71) Applicants: Yijing Yin Stehle, Wappingers Falls, NY (US); Xuesong Li, Wappingers Falls, NY (US); Yu-Ming Lin, West Harrison, NY (US); Chun-Yung Sung, Poughkeepsie, NY (US)

(72) Inventors: Yijing Yin Stehle, Wappingers Falls, NY (US); Xuesong Li, Wappingers Falls, NY (US); Yu-Ming Lin, West Harrison, NY (US); Chun-Yung Sung, Poughkeepsie, NY (US)

(73) Assignee: BLUESTONE GLOBAL TECH LIMITED, Wappingers Falls, NY (US)

(21) Appl. No.: 13/603,786

(22) Filed: Sep. 5, 2012

(51) Int. Cl. B32B 38/10; B82Y 40/00

(52) U.S. Cl. 156/236; 156/230; 977/891

(57) ABSTRACT

Aspects of the invention are directed to a method of forming a thin film adhered to a target substrate. The method comprises the steps of: (i) forming the thin film on a deposition substrate; (ii) depositing a support layer on the thin film; (iii) removing the deposition substrate without substantially removing the thin film and the support layer; (iv) drying the thin film and the support layer while the thin film is only adhered to the support layer; (v) placing the dried thin film and the dried support layer on the target substrate such that the thin film adheres to the target substrate; and (vi) removing the support layer without substantially removing the thin film and the target substrate.

### FIELD OF THE INVENTION

The present invention relates generally to nanotechnology, and, more particularly, to processing methods for graphene and like materials.

### BACKGROUND OF THE INVENTION

Synthesis of graphene on copper foils by chemical vapor deposition (CVD) is a promising method for the synthesis of high quality, large area graphene films. However, graphene applications frequently require a substrate different from copper (e.g., aluminum, nickel, silicon dioxide, sapphire, polyethylene terephthalate (PET)). As a result, a graphene film grown by CVD must frequently be transferred from the substrate on which it was originally grown to a different substrate that is suitable for a particular technological application. In performing this transfer from one substrate to another, it is critical that the graphene film not be degraded (e.g., cracked or torn) or contaminated.

One method of performing such a transfer between substrates utilizes a layer of poly (methyl methacrylate) (PMMA) to support and protect the CVD graphene during the transfer process, although this method is not admitted as prior art by its discussion in this Background Section. Briefly, after depositing a film of graphene on a copper foil substrate by CVD, a layer of PMMA is coated on the graphene to yield a PMMA/graphene/copper film stack. At this point, the copper foil is etched away by floating the film stack on the surface of a copper etchant (e.g., an aqueous solution of iron chloride or iron nitrate) with the copper foil substrate facing downward. After the copper is removed, the remaining PMMA/graphene film stack is lifted off the copper etchant's surface and sequentially floated on several different deionized water baths (e.g., three to ten different deionized water baths) with the graphene still facing downward in order to clean the graphene. Once the graphene is clean, a new substrate is then immersed in the deionized water bath under the PMMA/graphene film stack and lifted upward until the PMMA/graphene film stack rests on the new substrate. A PMMA/graphene/new-substrate film stack is thereby produced. The new film stack is allowed to dry and then the PMMA is selectively stripped (i.e., removed) by acetone to yield a layer of graphene on the new substrate.

While capable of producing the desired result, practicing the above-described substrate transfer process with PMMA has several disadvantages. During processing, the PMMA support layer needs to be thin enough (e.g., several hundred nanometers to several micrometers) to allow the graphene to obtain good adhesion between the PMMA/graphene film stack and the new substrate, and to also allow the PMMA/graphene film stack to be buoyant enough to float. As a result the PMMA support layer is very weak and easy to break. Thus, after the original copper foil substrate is removed and before the new substrate is introduced, the PMMA/graphene film stack needs to be handled very carefully to avoid damage. Generally, the PMMA/graphene film stack cannot be allowed to become freestanding, but instead needs to be left floating on the surface of a liquid bath. During those short periods of time when the film stack is being transferred from one liquid bath to another, the PMMA/graphene film stack needs to be supported by an additional transfer substrate such as a portion of a silicon wafer. In so doing, the PMMA/graphene film stack must stay wet so that it easily releases from the transfer substrate and does not adhere to the transfer substrate. These various constraints make the transport of the PMMA/graphene film stack over long distances difficult. Thus, the ability to produce the PMMA/graphene film stack at one location and then ship it to a remote location for deposition on a new substrate at that remote location is problematic.

PMMA, moreover, is not a particularly attractive material for use in these applications. When PMMA is purchased in solution, it is usually received in a solvent comprising chlorobenzene or anisole, both of which are harmful to human health. Moreover, PMMA tends to leave residues when removed by acetone. As a result, the use of PMMA may require additional processing (e.g., thermal annealing) to obtain a suitably clean graphene film after the PMMA is stripped.

For the foregoing reasons, there is a need for alternative methods of transferring graphene and like materials between substrates that address the above-identified disadvantages.

### SUMMARY OF THE INVENTION

Embodiments of the present invention address the above-identified needs by providing novel methods of transferring a thin film such as graphene from one substrate to another substrate.

Aspects of the invention are directed to a method of forming a thin film adhered to a target substrate. The method comprises the steps of: (i) forming the thin film on a deposition substrate; (ii) depositing a support layer on the thin film; (iii) removing the deposition substrate without substantially removing the thin film and the support layer; (iv) drying the thin film and the support layer while the thin film is only adhered to the support layer; (v) placing the dried thin film and the dried support layer on the target substrate such that the thin film adheres to the target substrate; and (vi) removing the support layer without substantially removing the thin film and the target substrate.

Advantageously, the above-identified embodiments make the processing of thin films such as graphene easier, safer, and less expensive, while, at the same time, providing a means by which these thin films can be more readily transported and stored before being placed on a final substrate.

### BRIEF DESCRIPTION OF THE DRAWINGS

These and other features, aspects, and advantages of the present invention will become better understood with regard to the following description, appended claims, and accompanying drawings where:

FIGS. 1A-1H show sectional views of structures in a processing sequence in accordance with an illustrative embodiment of the invention for forming a support-layer/graphene film stack;

FIGS. 2A-2D show sectional views of structures in a first processing sequence in accordance with an illustrative embodiment of the invention for utilizing a support-layer/graphene film stack to adhere the graphene film to a new substrate;

FIGS. 3A-3C show sectional views of structures in a second processing sequence in accordance with an illustrative embodiment of the invention for utilizing a support-layer/graphene film stack to adhere the graphene film to a new substrate; and

FIG. 4 shows a side elevational view of an alternative process for cleaning a support-layer/graphene film stack in accordance with an illustrative embodiment of the invention.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

Aspects of the invention are directed to novel methods for transferring a thin film from one substrate to another substrate (a “substrate transfer”). For purposes of this description, it will be assumed that the thin film comprises graphene, although this need not be the case and other materials would also come within the scope of the invention.

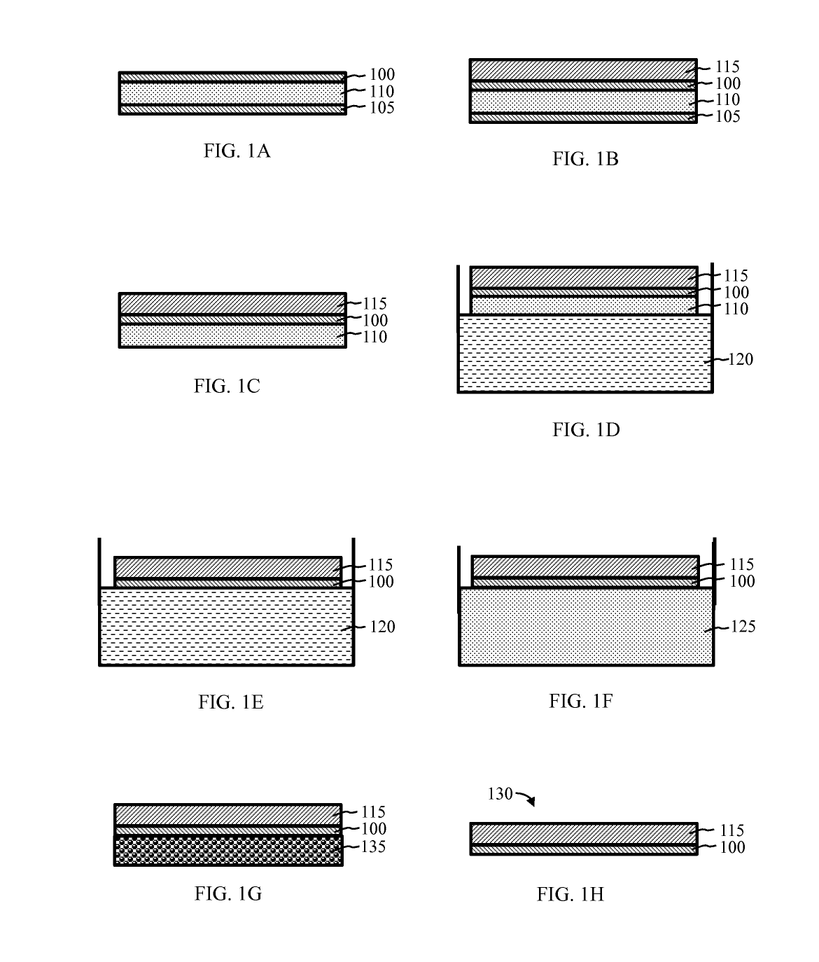

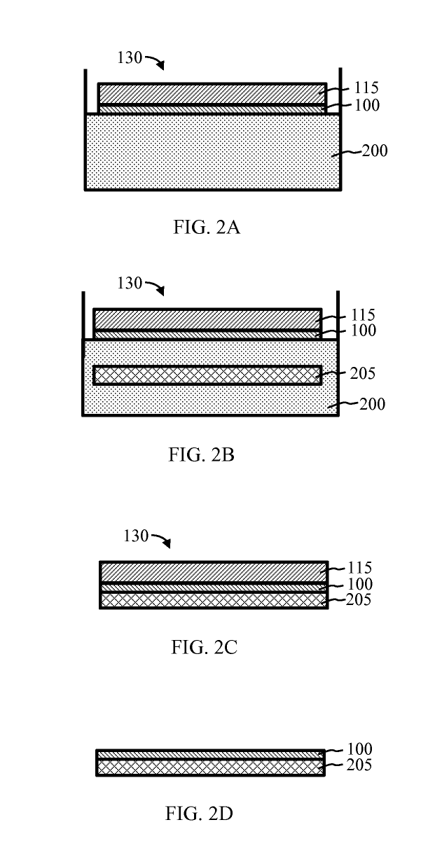

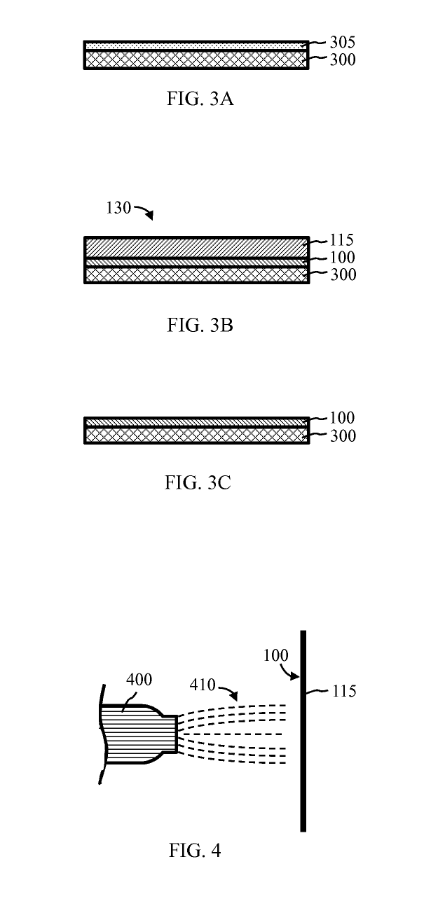

In general terms, a processing sequence for accomplishing a substrate transfer in accordance with aspects of the invention can be conceptually divided into two phases. FIGS. 1A-1H show sectional views of structures in an illustrative processing sequence for accomplishing the first phase. Processing in the first phase acts to form a dry film stack substantially consisting of a support layer adhered to a graphene film (a “support-layer/graphene film stack”). FIGS. 2A-2D and 3A-3C, in turn, show sectional views of respective structures in two alternative illustrative processing sequences for performing the second phase. Processing in the second phase utilizes the dry support-layer/graphene film stack formed in the first phase to adhere the graphene film to a new substrate and to ultimately eliminate the support layer.

Notably, while processing sequences falling within the scope of the invention are entirely novel and nonobvious, they still utilize several fabrication techniques (e.g., chemical vapor deposition (CVD), oxygen plasma etching, spray coating, wet etching, and drying) that will already be familiar to one having ordinary skill in, for example, the semiconductor or nanotechnology fabrication arts. Many of these conventional fabrication techniques are also described in readily available publications, such as: W. Choi et al., Graphene: Synthesis and Applications, CRC Press, 2011; D. B. Mitzi, Solution Processing of Inorganic Materials, John Wiley & Sons, 2009; M. Kohler, Etching in Microsystem Technology, John Wiley & Sons, 2008; P. M. Martin, Handbook of Deposition Technologies for Films and Coatings: Science, Applications, and Technology, William Andrew, 2009; and E. Tsotsas et al., Modern Drying Technology: Product Quality and Formulation, John Wiley & Sons, 2011, which are all hereby incorporated by reference herein. The conventional nature of many of the fabrication techniques further facilitates the use of largely conventional and readily available tooling. The CVD described herein may, for example, be performed in a CVD tube furnace available from, for example, MTI Corporation (Richmond, Calif., USA). Oxygen plasma etching may be performed in tools available from several vendors including, as just one example, PlasmaEtch Inc. (Carson City, Nev., USA).

Formation of the support-layer/graphene film stack, and thus the beginning of the first phase of the substrate transfer process, starts in FIG. 1A with the formation of a structure comprising an upper graphene film 100 and a lower graphene film 105 that are disposed on opposing surfaces of a deposition substrate 110. Each of the graphene films 100, 105 substantially comprises a respective one-atomic-layer-thick sheet of sp²-hybridized carbon, while, in the present embodiment, the deposition substrate 110 comprises copper. The graphene films 100, 105 are deposited by CVD, although other deposition methods are also contemplated (e.g., plasma-enhanced CVD, atomic layer deposition). The CVD of graphene on copper is detailed in, for example, U.S. Patent Publication No. 2011/0091647 to Colombo et al. and entitled “Graphene Synthesis by Chemical Vapor Deposition,” which is hereby incorporated by reference herein. This reference teaches loading a copper substrate into a largely conventional CVD tube furnace and introducing hydrogen gas at a rate between 1 to 100 standard cubic centimeters per minute (sccm) while heating the substrate to a temperature between 400 degrees Celsius (° C.) and 1,400° C. These conditions are maintained for a duration of time between 0.1 to 60 minutes. Next methane (CH₄) is introduced into the CVD tube furnace at a flow rate between 1 to 5,000 sccm at between 10 mTorr to 780 Torr of pressure while reducing the flow rate of hydrogen gas to less than 10 sccm. Graphene is synthesized on the metal substrate over a period of time between 0.001 to 10 minutes following the introduction of the methane. The same reference also teaches that the size of CVD graphene sheets (i.e., size of CVD graphene domains) may be controlled by varying CVD growth parameters such as temperature, methane flow rate, and methane partial pressure.

Subsequent processing acts to deposit a support layer 115 on the structure shown in FIG. 1A to create the structure shown in FIG. 1B. The support layer material is preferably chosen to have several characteristics, many of which clearly distinguish it from PMMA. The support layer material is, for example, preferably a material that is deposited as a liquid and then readily hardens into a solid at least in part as a result of solvent evaporation. The support layer material, moreover, is preferably of sufficient strength when hardened so as to allow a support-layer/graphene film stack to be supported at one corner or edge (e.g., by a set of tweezers or the like) without the graphene film tearing, cracking, or otherwise being damaged. The support layer 115 is also preferably substantially removed by acetone (C₃H₆O) without leaving residues, but is stable in water and alcohols. Furthermore, the support layer material preferably includes a solvent that is less toxic to humans than chlorobenzene or anisole. Finally, the material for the support layer 115 is preferably of high stability when hardened and is readily available at relatively low cost.

Suitable materials for the support layer 115 include, but are not limited to, solutions comprising a polymeric material such as, but not limited to, nitrocellulose, polyurethane, and polycrylic in an appropriate volatile solvent. The support layer 115 may also benefit from the inclusion of a plasticizer such as camphor, which acts to give the hardened material added flexibility. Aspects of the invention were actually reduced to practice with excellent results, for example, utilizing a conventional nail polish acquired from a local drugstore as well as a lacquer acquired from a local hardware store. The nail polish comprised nitrocellulose dissolved in ethyl acetate, butyl acetate, tri benzoin, propyl acetate, acetyl tributyl citrate, and hyroxybenzoate, and further included camphor as a plasticizer. The lacquer, in turn, comprised nitrocellulose dissolved in propane, naptha, toluene, ethylbenzene, xylene, 2-propanol, acetone, methyl ethyl ketone, isopropyl acetate, ethyl 3-ethyoxypropionate, n-buyl acetate, and amyl acetate. Additionally, aspects of the invention were likewise demonstrated utilizing polyurethane- and polycrylic-based support layers. Coating (i.e., deposition) of the support layer 115 may be by spray coating, spin coating, or dip coating. Subsequent to deposition of the support layer 115 as a liquid, hardening can be allowed to occur at room temperature or may be enhanced by mild baking, for example, on a hot plate or under an infrared lamp.

With the support layer 115 now in place over the upper graphene film 100, subsequent processing acts to remove the lower graphene film 105 to yield the structure shown in FIG. 1C. Removal of the lower graphene film 105 may be conducted by, for example, exposing the lower graphene film 105 to an oxygen plasma (i.e., oxygen plasma etching). The structure in FIG. 1C is then placed on a liquid bath comprising a copper etchant 120, as shown in FIG. 1D. In so doing, the structure in FIG. 1C is placed with the deposition substrate 110 facing downward. The copper etchant 120 may be any etchant capable of selectively etching away (i.e., removing) the deposition substrate 110 without substantially etching (i.e., removing) the upper graphene film 100 or the support layer 115. A non-limiting example of a suitable selective etchant is an aqueous solution of iron chloride (FeCl₃) or iron nitrate (Fe(NO₃)₃). After the deposition substrate 110 is removed in this manner, the upper graphene film 100 and the support layer 115 remain floating on the surface of the liquid bath, as shown in FIG. 1E.

The upper graphene film 100 in the structure shown in FIG. 1E may now be cleaned by floating the upper graphene film 100 and the adhered support layer 115 on one, or preferably several, liquid baths comprising deionized water 125, with the upper graphene film 100 facing downward as shown in FIG. 1F. Here, the initial transfer of the support layer 115 and the graphene film 100 from the liquid bath in FIG. 1E to one like that shown in FIG. 1F, and thereafter between subsequent deionized water baths, is made easy by the support layer 115. That is, the transfers between liquid baths are as easy as picking up the combination of the support layer 115 and the upper graphene film 100 with a suitable grasping device (e.g., tweezers) and moving them as a substantially freestanding entity. No extra support substrates are required as would be necessary were one using PMMA.

Once any remnants of the copper etchant 120 and any etching by-products are sufficiently removed, the upper graphene film 100 and the support layer 115 may be dried. Drying may be accomplished by placing the support layer 115 and the upper graphene film 100 on a drying substrate 135 that has a relatively rough upper surface, as shown in FIG. 1G. The drying substrate 135 may comprise, for example, a clean-room-compliant paper or cloth. In so doing, the roughness of the upper surface of the drying substrate 135 assures that the upper graphene film 100 does not substantially adhere to the drying substrate 135. In this manner, the upper graphene film 100 remains only substantially adhered to the support layer 115 during drying. The actual drying may again be by evaporation at room temperature or may utilize mild baking. With the drying accomplished, a dry support-layer/graphene film stack 130 as shown in FIG. 1H is formed, thereby ending the first phase of processing. At this point, the support-layer/graphene film stack 130 may be stored or may be transported to a remote location before undertaking the second phase of the substrate transfer. During storage and transport, the support-layer/graphene film stack 130 may remain dry and, unlike the case were the support layer PMMA, need not be maintained floating on the surface of a liquid. Storage and transport are thereby greatly facilitated by using a processing methodology in accordance with aspects of the invention.

As was indicated above, the second phase of processing is directed at completing the substrate transfer by utilizing the dried support-layer/graphene film stack 130 created in the first phase of processing to adhere the upper graphene film 100 to a new substrate and ultimately eliminate the support layer 115. Two alternative illustrative methodologies for performing the second phase of processing are now presented with reference to FIGS. 2A-2D and FIGS. 3A-3C.

The first of the illustrative processing sequences for performing the second phase of processing starts in FIG. 2A by placing the support-layer/graphene film stack 130 on the surface of a liquid bath comprising deionized water 200 so that the film stack 130 is again floating on the surface of a liquid with the upper graphene film 100 facing downward. Subsequently, a new substrate 205 (e.g., copper, aluminum, nickel, silicon dioxide, sapphire, quartz, PET, stainless steel) is immersed in the liquid bath so that it is positioned under the floating support-layer/graphene film stack 130 as shown in FIG. 2B. The new substrate 205 is then raised upward and out of the liquid bath until the new substrate 205 supports the support-layer/graphene film stack 130 outside the liquid bath, as shown in FIG. 2C. The structure shown in FIG. 2C is, at that point, allowed to dry by evaporation with or without mild baking. In so doing, elimination of the liquid causes the upper graphene film 100 to adhere to the new substrate 205 as a result of van der Waals forces. Finally, the structure in FIG. 2C is exposed to a solvent that is able to selectively remove the support layer 115 without substantially removing the upper graphene film 100 or the new substrate 205. The etchant may, for example, comprise acetone and the removal process may be by simple rinsing. If desired, the resultant structure may further be rinsed with isopropanol (C₃H₈O) and blow dried. Ultimately, the structure shown in FIG. 2D is formed, namely a structure in which the upper graphene film 100 is adhered to the new substrate 205. The substrate transfer process is thereby completed.

The second of the illustrative processing sequences for performing the second phase of processing instead starts in FIG. 3A, wherein an upper surface of a new substrate 300 is wetted by a liquid solution 305. This wetting is preferably accomplished by a solution that does not etch, corrode, or otherwise damage the new substrate 300, and also does not substantially etch the constituents of the support-layer/graphene film stack 130. Suitable wetting liquids may include, but are not limited to, deionized water, an alcohol, and benzene. The wetting may be accomplished by, for example, spraying the upper surface of the new substrate 300 with the liquid solution 305. In so doing, the new substrate 300 is never actually immersed in a liquid, as was the case in the prior processing embodiment set forth with reference to FIGS. 2A-2D. If the new substrate 300 would be damaged by being so immersed, the present methodology advantageously avoids such a process.

Subsequently, the support-layer/graphene film stack 130 is placed on the now-wetted upper surface of the new substrate 300 with the upper graphene film facing downward 100. This structure is then allowed to dry by evaporation with or without mild baking to produce the structure shown in FIG. 3B. Here again, elimination of the liquid solution 305 causes the upper graphene film 100 to adhere to the new substrate 300 as a result of van der Waals forces. Finally, the structure in FIG. 3B is exposed to a solvent such as acetone that is able to selectively remove the support layer 115 without substantially removing or harming the upper graphene film 100 or the new substrate 300. The resultant structure may again be further rinsed with isopropanol and blow dried. After removing the support layer 115, the structure shown in FIG. 3C is formed, namely a structure in which the upper graphene film 100 is adhered to the new substrate 300. The substrate transfer process is thereby again completed.

It should again be emphasized that the above-described embodiments of the invention are intended to be illustrative only. Other embodiments can use different processing steps and materials for implementing the described functionality and the results would still come within the scope of the invention. These numerous alternative embodiments within the scope of the appended claims will be apparent to one skilled in the art given the teachings herein.

For example, in cleaning the upper graphene film 100 and its support layer 115 while forming the support-layer/graphene film stack 130 in FIGS. 1A-1H, the upper graphene film 100 is cleaned by transferring it and its support layer 115 between one or more liquid baths comprising deionized water 125 (FIG. 1F). Nevertheless, the freestanding nature of the upper graphene film 100 and the support layer 115 at this point in the processing, that is, the ability of this film stack to remain intact while being supported by a corner or edge, helps to facilitate alternative and possibly more efficient processing techniques. In one or more alternative embodiments, the upper graphene film 100 may instead be cleaned by simply spraying it with deionized water. FIG. 4 shows a side elevational view of such a process. Here, a nozzle 400 is utilized to spray deionized water 410 onto the upper graphene film 100, which is backed by the support layer 115 and is suspended vertically.

All the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

Any element in a claim that does not explicitly state “means for” performing a specified function or “step for” performing a specified function is not to be interpreted as a “means for” or “step for” clause as specified in 35 U.S.C. §112, ¶6. In particular, the use of “step of” in the claims herein is not intended to invoke the provisions of 35 U.S.C. §112, ¶6.

What is claimed is:

1. A method of forming a thin film adhered to a target substrate, the method comprising the steps of:
(i) forming the thin film on a deposition substrate;
(ii) depositing a support layer on the thin film;
(iii) removing the deposition substrate without substantially removing the thin film and the support layer;
(iv) drying the thin film and the support layer while the thin film is only adhered to the support layer;
(v) placing the dried thin film and the dried support layer on the target substrate such that the thin film adheres to the target substrate; and
(vi) removing the support layer without substantially removing the thin film and the target substrate.

2. The method of claim 1, wherein the thin film comprises graphene.

3. The method of claim 1, wherein step (i) comprises chemical vapor deposition.

4. The method of claim 3, wherein the chemical vapor deposition utilizes at least methane and hydrogen.

5. The method of claim 1, wherein the deposition substrate comprises copper.

6. The method of claim 1, wherein step (ii) comprises depositing a liquid on the thin film, the liquid adapted to harden into the support layer at least in part by evaporation of a solvent.

7. The method of claim 6, wherein the solvent comprises at least one of an acetate, a ketone, and propane.

8. The method of claim 6, wherein the liquid comprises a plasticizer.

9. The method of claim 1, wherein the support layer is adapted to support the thin film after step (iii) and before step (vi) such that the support layer and the thin film can be supported at a corner or an edge without the thin film tearing or cracking

10. The method of claim 1, wherein step (ii) comprises at least one of spray coating, dip coating, and spin coating.

11. The method of claim 1, wherein the support layer comprises a material that is substantially removed by acetone.

12. The method of claim 1, wherein the support layer is not substantially etched by water.

13. The method of claim 1, wherein the support layer comprises a polymeric material.

14. The method of claim 1, wherein the support layer comprises nitrocellulose.

15. The method of claim 1, wherein the support layer comprises polyurethane.

16. The method of claim 1, wherein the support layer comprises polycrylic.

17. The method of claim 1, wherein step (iii) comprises wet chemical etching in a solution comprising at least one of iron chloride and iron nitrate.

18. The method of claim 1, wherein step (iv) is performed by evaporation.

19. The method of claim 1, further comprising the step of washing the thin film after step (iii) and before step (iv).

20. The method of claim 19, wherein the washing step comprises floating the thin film and the support layer on a liquid bath with the thin film facing downward.

21. The method of claim 19, wherein the washing step comprises exposing the thin film to a liquid spray.

22. The method of claim 1, wherein the target substrate comprises at least one of aluminum, copper, nickel, silicon dioxide, sapphire, quartz, polyethylene terephthalate, and stainless steel.

23. The method of claim 1, wherein step (v) comprises the steps of:
floating the dried thin film and the dried support layer on a liquid with the thin film facing downward;
immersing the target substrate in the liquid under the floating thin film;
raising the target substrate upward until the target substrate supports the thin film and the support layer; and
drying the thin film and the target substrate to cause the thin film to adhere to the target substrate.

24. The method of claim 1, wherein step (v) comprises the steps of:
wetting a surface of the target substrate without immersing the target substrate in a liquid;
disposing the dried thin film and the dried support layer on the wetted surface such that the thin film contacts the wetted surface; and
drying the wetted surface to cause the thin film to adhere to the target substrate.

25. The method of claim 1, wherein step (vi) is performed using a solution comprising acetone.
